(19) United States
(12) Patent Application Publication
(10) Pub. No.: US 2012/0256054 A1
(43) Pub. Date: Oct. 11, 2012

(54) SYSTEM AND METHOD FOR AUTOMATIC RELEASE OF A PARACHUTE FROM LOAD UPON LANDING

(76) Inventor: Eliahu TAYAR, Moshav Ramat Tzvi (IL)

(21) Appl. No.: 13/438,916

(22) Filed: Apr. 4, 2012

Related U.S. Application Data
(60) Provisional application No. 61/471,984, filed on Apr. 5, 2011.

(51) Int. Cl. B64D 17/38

(52) U.S. Cl. 244/151 B

(57) ABSTRACT

A connecting means and method are disclosed for enabling automatic release of load hanging from a carrying means, connected by connecting means, when sudden decrease of the force exerted by the load on the connecting means is experienced. The connecting means comprise two main connecting assemblies adapted to connect to each other by means of matching sets of jags. One set of jags is provided on a set of levers adapted to get apart and release the connecting latch when, due to a sudden decrease of the force exerted by the load, the first connecting assembly gets closed to the second connecting assembly. According to embodiments of the invention the connecting means may comprise safety mechanism ensuring the stage of automatic release will be activated only after the load is securely carried by the carrying means.

### CROSS REFERENCE TO RELATED APPLICATIONS

This Application claims the benefit of U.S. Provisional Application Ser. No. 61/471,984, filed Apr. 5, 2011, which is hereby incorporated by reference in its entirety.

### BACKGROUND OF THE INVENTION

Supplies and loads may be parachuted from an airplane in many circumstances and for addressing various needs. Typically the parachuted load falls not exactly at the desired parachuting target point due to various factors such as changing wind, inaccurate point of releasing from the airplane, variances in the open-and-deployment of the parachute, and the like.

As a result the load may hit the ground at the end of the parachuting distal from the waiting recipient. When a wind is blowing on the ground the parachute of the landing load may be blown open and with strong enough wind it may turn the load over, drag it on the ground and even pull it beyond a cliff, into water, etc.

There is a need for a system and method that will automatically release a parachute from its associated load after the load has landed, but will securely connect the load to the parachute at any other time and stage of operation prior to the landing on the ground.

### SUMMARY OF THE INVENTION

A connecting means and respective method are disclosed for enabling automatic release of load hanging from a carrying means, connected by connecting means, when sudden decrease of the force exerted by the load on the connecting means is experienced. The connecting means comprise two main connecting assemblies adapted to connect to each other by means of matching sets of jags. One set of jags is provided on a set of levers secured to provide latch when in operational stage by springs. The set of levers is adapted to get apart and release the connecting latch when, due to a sudden decrease of the force exerted by the load, the first connecting assembly gets closed to the second connecting assembly. As a result the first and the second connecting assemblies depart from each other and thus automatically releasing the load from the carrying means. According to some embodiments the carrying means may be a parachute and the automatic release may occur upon landing of the load on the ground. According to embodiments of the invention the connecting means may comprise safety mechanism ensuring the stage of automatic release will be activated only after the load is securely carried by the carrying means.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of system for automatic release, or disconnection, of a parachute from its load, or package, upon its landing on the ground, according to embodiments of the present invention;

FIG. 2 is a schematic illustration of first assembly of the system of FIG. 1, according to embodiments of the present invention;

FIG. 3 is a schematic illustration of second assembly of the system of FIG. 1, according to embodiments of the present invention;

FIG. 4 depicts the system of FIG. 1 in an assembled position according to embodiments of the present invention;

FIG. 5 depicts the system of FIG. 1 in its second operational stage, according to embodiments of the present invention;

FIG. 6 depicts the system of FIG. 1 in its third operational stage, according to embodiments of the present invention;

FIG. 7 depicts the system of FIG. 1 in its fourth operational stage, according to embodiments of the present invention; and

FIG. 8A is a flow diagram of a method for releasing connection between two connecting points when the force between them drops dramatically according to embodiments of the present invention; and

FIG. 8B is a graph of the relation between the force exerted on the connecting system and its modes of operation, according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

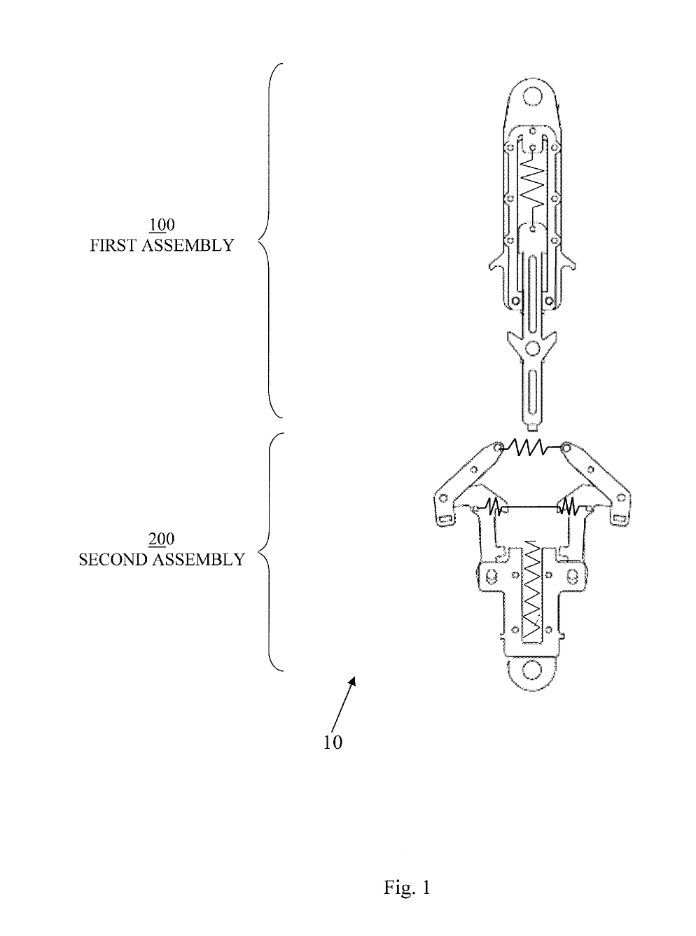

Reference is made now to FIG. 1, which is a schematic illustration of system 10 for automatic release, or disconnection, of a parachute from its load, or package hanging from it, upon its landing on the ground, according to embodiments of the present invention. System 10 includes first assembly 100 and second assembly 200. Assemblies 100 and 200 are adapted to be connected to each other so as to allow supporting connection of a load hanging from second assembly 200 to a parachute connected to first assembly 100. In other phase of operation assemblies 100 and 200 may be disconnected from each other. Assemblies 100 and 200 are shown in FIG. 1 in their disconnected position.

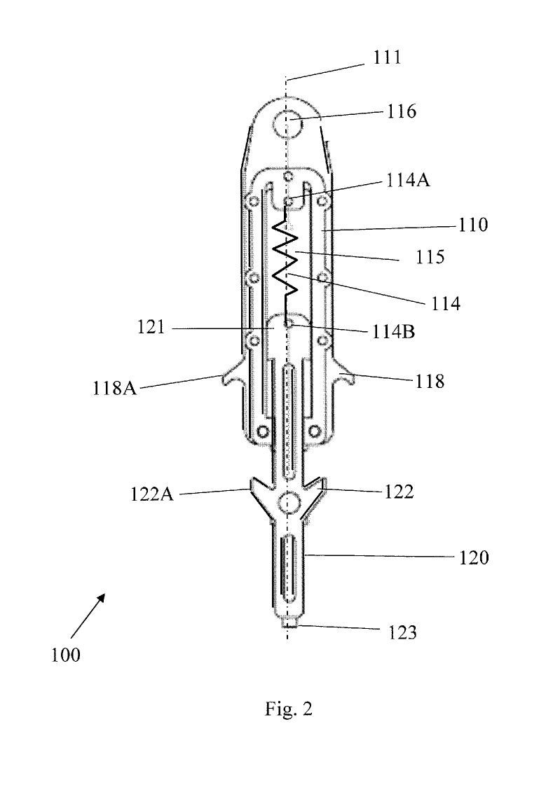

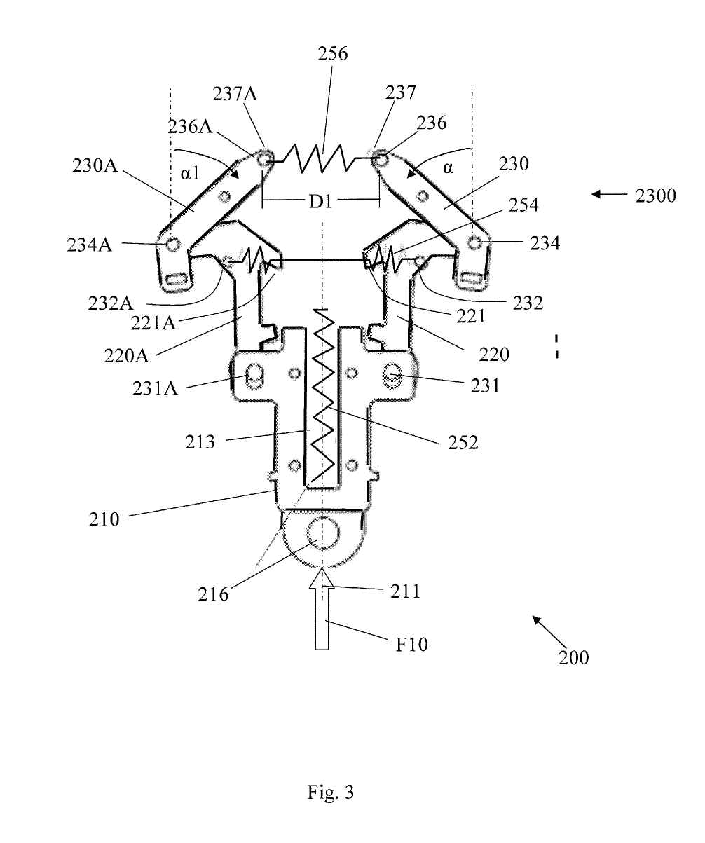

Reference is made now to FIG. 2, which is a schematic illustration of first assembly 100 of system 10, according to embodiments of the present invention. Assembly 100 includes housing 110 and connecting element 120. Housing 110 and connecting element 120 extend longitudinally along imaginary longitudinal line 111. Housing 110 has an elongated cavity 115 adapted to host connecting element 120 and to allow a free movement of its first end 121 inside cavity 115 along longitudinal line 111 and away from connecting point 116 as much as the ends of cavity 115 and the protrusion of first end 121 will allow. Spring 114 may be connected between connecting point 114A inside and at one end of cavity 115 and connecting point 114B made at first end 121 of connecting element 120. Jags 118, 118A (at least two) may be placed on the outer face of housing 110. Their exact location along the outer face of housing 110 is dictated by the location of respective jags 236, 236A of second assembly 200, as will be explained in details in reference to FIG. 3. The general shape of jags 118, 118A is similar to a right-angle triangle having its inclined side extending from the outer face of housing 110 outwardly (away from the face of housing 110) as the distance from connecting point 116 grows and having the right-angle side extending in substantially right angle from the outer face of housing 110 towards the inclined side of the triangle. Spring 114 is adapted to extend when connecting element 120 is pulled outside of housing 110 (i.e. away from connecting point 116) so as to provide a first defined pulling force F1 when extended to its maximal outside position. First pulling force F1 may be, for example, about 20 kg, according to embodiments of the present invention. It will be noted that at no time and circumstances connecting element 120 may be pulled out completely from housing 110. Assembly 100 may include a first load connecting point 116 at its first end, distal from connecting element 120. The distal end of connecting element 120, located away from spring connecting point 114B, is denoted 123. Connecting element 120 may have installed or otherwise connected to the portion of connecting element 120 protruding outside of housing 110, a pair (or more) of jags 122, 122A . Jags 122, 122A are formed as an arrow head pointing towards distal end 123 so as to enable smooth movement of connecting element 120 and jags 122, 122A between springy barriers (as is explained with reference to FIG. 3) when extending out of housing 110 and to latch on such springy barrier when connecting element 120 moves back into housing 110, as is explained in details herein below.

Reference is made now to FIG. 3, which is a schematic illustration of second assembly 200 of system 10, according to embodiments of the present invention. Assembly 200 includes a second housing 210, a first at least two levers 220, 220A and a second at least two levers 230, 230A. Second housing 210 may have cavity 213 made along its longitudinal axis 211 and adapted to host spring 252. Second load connecting point 216 may be located at a first end of second housing 210. First at least two levers 220, 220A may be pivotally connected at the second end of second housing 210 at pivotal points 231, 231A respectively. Pivotal points 231, 231A may enable pivotal movement of levers 220, 220A, respectively about these points so as to get closer to or away from longitudinal axis 211 of second housing 210. Levers 220, 220A may be connected to each other by a springy element, such as spring 254, which as selected so, and adapted to provide a second predefined pulling force F2 to ensure that levers 220, 220A are brought away from each other only when pulling-away force that is greater than F2 is applied at pivotal points 234, 234A perpendicularly to longitudinal axis 211.

Second at least two levers 230, 230A may be pivotally connected to first at least two levers 220, 220A at pivotal points 234, 234A respectively which are made at the distal ends from pivotal points 231, 231A. Pivotal points 234, 234A may enable pivotal movement of levers 230, 230A, respectively about these points so as to get closer to or away from longitudinal axis 211 of second housing 210. Springy element, such as spring 256 may be connected between connecting points 236, 236A or close thereto and may be selected so as to provide a third predefined pulling force F3 to ensure that levers 230, 230A are brought away from each other only when pulling-away force that is greater than F3 is applied at connecting points 236, 236A. First at least two levers 220, 220A may be provided with limiters adapted to limit the pivotal movement of second at least two levers 230, 230A about pivotal points 234, 234A respectively, so that angles α, α1 created between levers 230, 230A respectively and longitudinal axis 211 are limited and as a result levers tips 237, 237A may not get closer to each other more than a predefined distance D1 even if spring 256 exerts force tending to bring them nearer.

According to embodiments of the present invention levers 230, 230A and their respective tips 237, 237A, form a springy barrier for an article (not shown) being pushed between tips 237, 237A longitudinally with second assembly 200 along longitudinally axis 211. It will be noted that pivotal points 231, 231A are closer, at all stages of operation of second assembly 200, to longitudinal axis 211 of second housing 210 than pivotal points 234, 234A. This may ensure that when a force is applied onto connecting point 216 substantially along longitudinal axis 211 as indicated by arrow F10, and a counter-force is applied at tip points 237, 237A, a pulling-apart force is induced at pivotal points 234, 234A and when this pulling-apart force is stronger than F2, pivotal points 234, 234A will get apart from each other, causing jags 221, 221A to get away from each other. Jags 221, 221A may be located on levers 220, 220A, respectively, between pivotal points 231, 231A and pivotal points 234, 234A, respectively and may point with their protrusions towards longitudinal axis 211 of housing 210. Cavity 213 is adapted to receive and host distal end 123 of connecting element 120 (FIG. 2) when system 10 is in its assembled position. When in assembled position distal end 123 is adapted to depress spring 252. The tip of ends of levers 230, 230A, next to connecting points 236, 236A, are denoted 237, 237A, respectively. These tips may be formed as small rollers to provide for smooth rolling of these tips when passing over jags 118, 118A (FIG. 2), during the process of applying load on system 10.

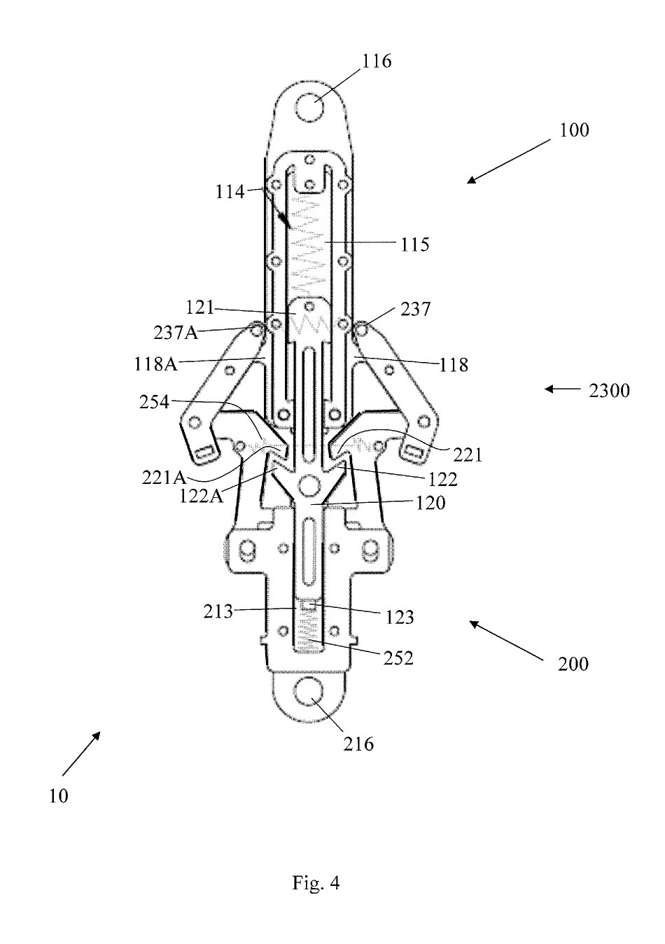

Reference is made now to FIG. 4, depicting system 10 in an assembled and ready-to-be-loaded position according to embodiments of the present invention. It will be appreciated that similar parts in FIGS. 2, 3 and 4 will be denoted by similar referrals. Further, in order not to obscure the description in FIG. 4 only some of the parts of system 10 have been numbered, however, referrals that do not appear in FIG. 4 may be taught from FIGS. 2 and 3. Still further, some elements of assemblies 100 and 200 were not drawn or were drawn in light grey to improve the readability and clarity of the drawing, such as springs 114, 121, 252 and 254. Nevertheless, all the elements and parts of assemblies 100 and 200, as shown in FIGS. 2 and 3 are part of these assemblies in FIG. 4. System 10 is seen in FIG. 4 in an initial operational stage, ready to be loaded, as will be described in details herein below. Assemblies 100 and 200 are shown assembled together such that connecting element 120 is inserted into cavity 213 and its distal end 123 depresses spring 252. Jags 122, 122A are placed abut jags 221, 221A of levers 220, 220A, respectively, in their mutually-locking position. The geometrical design of the lips of jags 122, 122A, 221 and 221A, which are made to touch each-other are shaped with inclined matching edges so as to act to secure the mechanical/geometrical latch between pairs of jags 122-221 and 122A-221A when connecting points 116, 216 are pulled away from each other, for example when connecting point 116 is tied to a parachute and connecting point 216 is connected to a load. The securing arrangement of the lips of jags 122, 122A, 221 and 221A may be achieved by a matching inclination of those lips with respect to longitudinal axis 211 of housing 210, so that when the pairs 122-221 and 122A-221A are pressed against each other jags 221, 221A tend to slide along the inclination toward longitudinal axis 211 of housing 210 and thus to secure this latch.

System 100 is shown in FIG. 4 in its initial, ready-to-be-loaded position, before a substantial force have been applied between connecting points 116 and 216 to pull them away from each other. It will be noted that due to the position of end 121 of connecting element 120 inside cavity 213, certain free movement of end 121 in a direction away from connecting point 116 is left at this stage. It will be noticed that system 10, as depicted in FIG. 4 in its initial position has tips 237, 237A of levers 230, 230A, respectively, placed on the side of jags 118, 118A that is closer to connecting point 116.

Levers 230, 230A form an unlocking mechanism 2300, adapted to pull apart levers 220, 220A from each other, as will be explained in details herein below. Unlocking mechanism 2300 may be in one of three main modes of operation, according to the stage of operation of system 10. First mode of operation of unlocking mechanism 2300 is depicted in FIG. 4 and will be denoted herein after the ‘safe mode’. In first mode of operation of mechanism 2300 tips 237, 237A are located between jags 118, 118A respectively and connecting point 116 and proximal to jags 118, 118A. At this stage of operation system 10 is ready to be connected between a load and a carrying means, such as a parachute. At this stage of operation unlocking mechanism 2300 may not be operated to unlock the connection between assembly 100 and assembly 200.

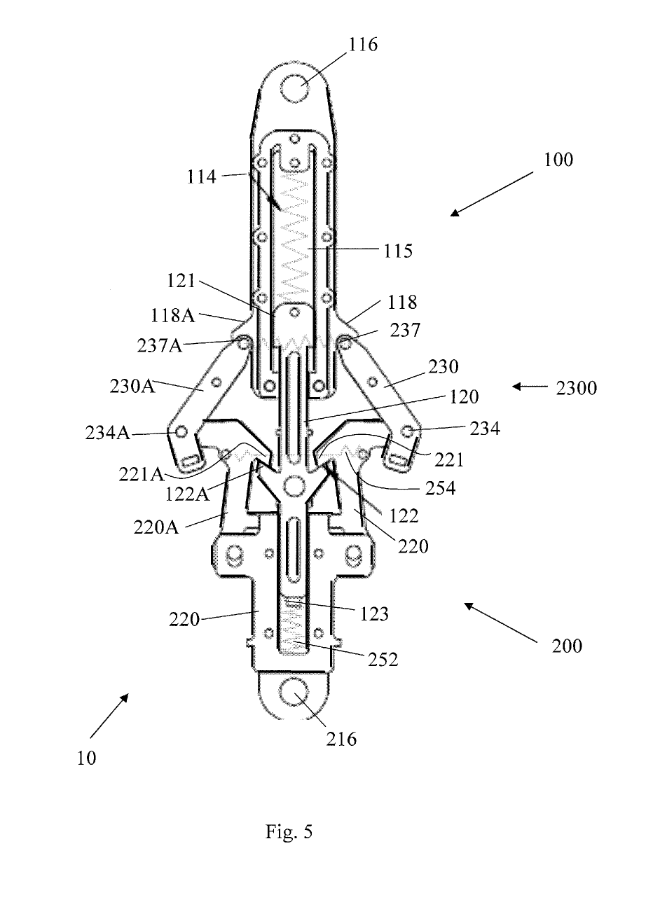

Reference is made now to FIG. 5, depicting system 10 in its second operational stage, after a pulling-apart force between connecting points 116 and 216 have been applied, according to embodiments of the present invention. As with respect to FIG. 4, in FIG. 5 also some parts were not numbered, and/or were drawn in light grey line and/or were not drawn at all, in order to present a more readable explanation of the operation of system 10. However, all the parts and elements of assemblies 100 and 200, as presented FIGS. 2 and 3, are part of these assemblies in the embodiment presented in FIG. 5. When assembly 200 is pulled, for example from connecting point 216, away from assembly 100, by a force exceeding the magnitude of force F1 the latch between jags 122-221 and 122A-221A causes connecting element 120 to be pulled along away from connecting point 116 and thus to extend spring 114. Additionally, the movement of assembly 200 away from assembly 100 due to the pulling force causes tips 237, 237A of levers 230, 230A to slide over jags 118, 118A, respectively and by that causing tips 237 and 237A to be forced away from each other against the returning force applied by spring 254 (see also in FIG. 3). The resistance of springs 114 and 254 to the movement of assembly 200 away from assembly 100 ensures that such movement will begin only if the pulling force applied, for example, at connecting points 116, 216 is larger than the combined resisting force. The combined resisting force may be adapted, by careful selection of those springs, to the needs and circumstances of use and, according to some embodiments, be in the order of tens to hundreds of kgs. According to one embodiment this force may be tuned to 100 kgs.

As depicted in FIG. 5, when assembly 200 is pulled away from assembly 100 far enough tips 237, 237A of levers 230, 230A pass over the protruding apex of jags 118, 118A, respectively, and are free to be pulled back towards each-other and thus towards the outer surface of housing 110. It will be noted that due to the asymmetrical design of jag 118, 118A, having moderate slope leading from the outer surface of housing 110 towards its apex when coming from the direction of connecting point 116, and a substantially reverse sharp slope on its other side, once tips 237, 237A pass over the apex of jags 118, 118A respectively during movement away from connecting point 116, their movement backwards, for example due to the applying of a reversed force between points 116-216, will not be able to cause tips 237, 237A to climb on and pass over jags 118, 118A.

The movement of assembly 200 away from assembly 100 is limited by the mechanical limit at the distal end of cavity 115, which is adapted to stop the movement of first end 121 of connecting element 120. At this position the pulling force between points 116-216 is larger than the returning force of spring 114 and the chain of elements that support and hold the pulling force from point 216 to point 116 are housing 220 that hangs on connecting element 120 via levers 220, 220A that lean on jags 122, 122A respectively and connecting element 120, in turn, that hangs on housing 110 as described above and finally housing element is connected to connecting point 116. This position may be considered as the operational position for continuous carrying of a load under support device, for example—a parachute.

Unlocking mechanism 2300 is depicted in FIG. 5 in its second mode of operation, denoted the ‘ready mode’. In this mode tips 237, 237A of levers 230, 230A are located on the side of jags 118, 118A distal from connecting point 116, which are formed to prevent movement of tips 237, 237A along housing 110 towards connecting point 116 beyond jags 118, 118A.

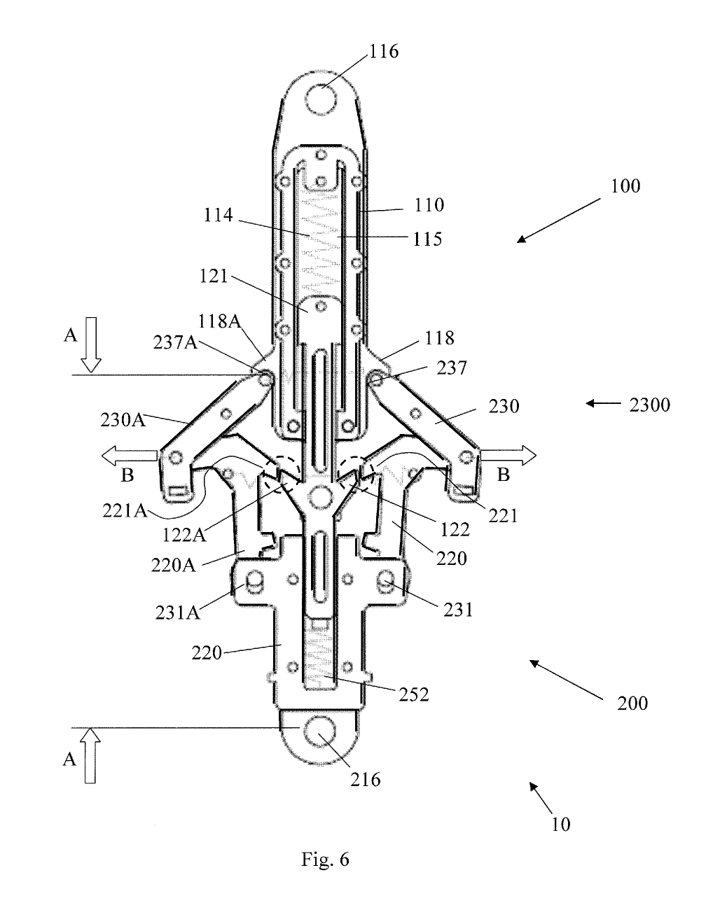

Reference is made now to FIG. 6, depicting system 10 in its third operational stage, after a pulling force between connecting points 116 and 216 have been decreased below a definable threshold fourth force F4, according to embodiments of the present invention. As with respect to FIGS. 4 and 5, in FIG. 6 also some parts were not numbered, and/or were drawn in light grey line and/or were not drawn at all, in order to present a more readable explanation of the operation of system 10. However, all the parts and elements of assemblies 100 and 200, as presented FIGS. 2 and 3, are part of these assemblies in the embodiment presented in FIG. 6. When the pulling force between points 116-216 decreases below force F4, for example few tens of kgs. (according to one embodiment this force may be 20-30 kgs.) the returning force exerted by extended spring 114 becomes greater than the pulling force between points 116-216 and as a result the pulling force that spring 114 activates on jags 221, 221A via jags 122, 122A causes housing 220 to be pulled towards housing 110. Since tips 237, 237A are locked against movement upwardly towards point 116 by jags 118, 118A, respectively, the pulling force of spring 114, as depicted by the pair of arrows denoted “A” causes the force exerted by jags 122, 122A on jags 221, 221A to rotate levers 220, 220A about their pivotal points 231, 231A and turn away from central longitudinal axis 211 of housing 210. As a result of this rotation jags 221, 221A slide off and away from jags 122, 122A, as depicted by pair of arrows denoted “B”, until these pairs of jags completely become detached from each other. At this point the mechanical connection between housing 110 and housing 210 is broken and assembly 200 is free to depart from assembly 100. When a parachute is connected to a load via device 10, the disconnection described above actually disconnects the parachute from the load after the load hits the ground at the end of parachuting and as a result the magnitude of the tension between points 116-216 drops dramatically.

Unlocking mechanism 2300 is depicted in FIG. 6 in its third mode of operation, denoted the ‘triggered mode’. In this mode tips 237, 237A of levers 230, 230A are being pushed by jags 118, 118A away from connecting point and towards connecting point 216 thus activating the unlocking operation, as described herein above.

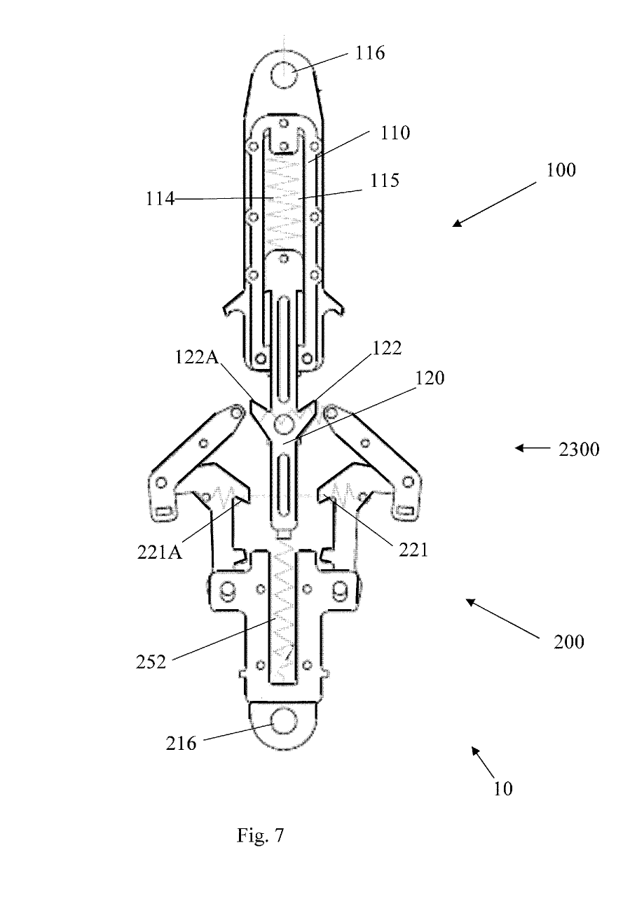

Reference is made now to FIG. 7, which schematically depicts system 10 in its fourth operational stage, after mechanical disconnection between assemblies 100 and 200 completes, according to embodiments of the present invention. As seen in FIG. 7 once jags 122, 122A are free from jags 221, 221A, connecting element 120 is free to move into cavity 115 by the returning force of extended spring 114. In order to ensure that an accidental force acting on point 116 perpendicularly to longitudinal axis 111 of housing 110 will not cause damage or undesired catching of assemblies 100 and 200 together, depressed spring 252 provides pushing action to connecting element 120, pushing it away from assembly 200 thus accelerating the disconnection process of assemblies 100 and 200 from each other. Accidental force acting on point 116 perpendicularly to longitudinal axis 111 of housing 110 may be, for example, due to a wind blowing at the parachute when the load is on the ground and the disconnection of assemblies 100 and 200 has not yet completed.

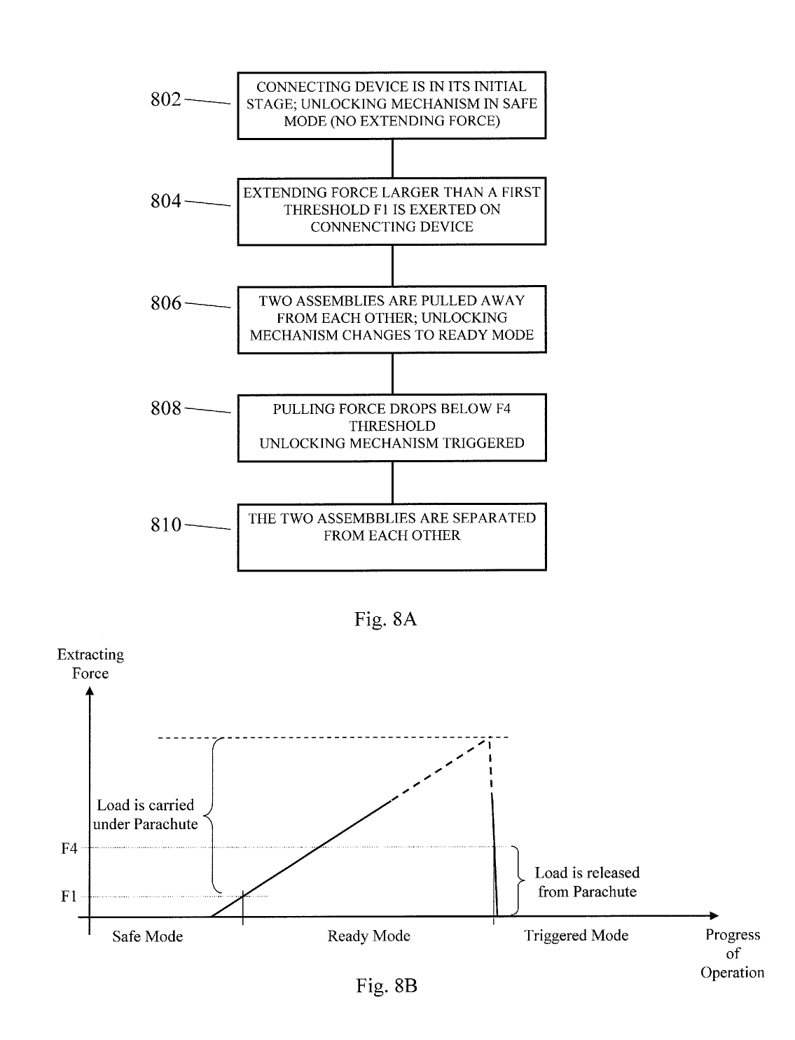

Reference is made now to FIG. 8A, which is a flow diagram of a method for releasing connection between two connecting points when the force between them drops dramatically, and to FIG. 8B, which is a graph of the relation between the force exerted on the connecting system and its modes of operation, according to embodiments of the present invention. System 10, made to connect a load to a carrying means such as a parachute, is in its initial operational stage and unlocking means is in its safe mode, where no extending force has been exerted to connecting points 116, 216 (block 802) as described with respect to FIG. 4. When an extending force is exerted on the pulling points of system 10, that is larger than a first definable threshold force F1 (block 804) assemblies 100 and 200 are pulled away from each other and as a result the unlocking mechanism is changed to its ready mode (block 806), as described with reference to FIG. 5. At this stage system 10 is in its load-carrying position and thus is continuously under pulling force (typically over 1 ton). When the load hanging from system 10 parachutes down and hits the ground the force exerted between the two ends of system 10 dramatically drops down and below a fourth threshold force F4 (block 808) which enables system 10 to retract under the force of extended spring 114 and by that to activate unlocking mechanism 2300 which takes assemblies 100 and 200 apart (block 810), as described with regards to FIGS. 6 and 7. As shown above, the operation of system 10, according to embodiments of the present invention, is according to the logical rules of a ‘state machine’, which ensures that certain state(s) or modes (in this case—the release of the two assemblies from one another) will occur only after preceding sate(s) have occurred in their right order (in this case—the transfer of unlocking mechanism from safe to ready mode due to the full-load extending force). The first and fourth thresholds may be defined to ensure safety operation.

FIG. 8B depicts a graph schematically showing the relation between the force exerted on the connecting system and the modes of operation of unlocking mechanism 2300, according to embodiments of the present invention. System 10 is initially in its first operational stage and unlocking mechanism 2300 is in its safe mode. When extracting force gradually grows and crosses the magnitude of F1 system 10 changes to its second operational stage and unlocking mechanism is changed to its ready mode. From here and as long as extracting force does not drop below the magnitude of F4 system 10 provides secured connection between a carried load and carrying means, such as a parachute. Once extracting force drops below F4 system 10 changes to its third and then to its fourth operational stages and unlocking mechanism 2300 changes to its triggered mode.

and when system 10 is used to connect a load to a descending parachute the rate of drop of extracting force is typically very fast

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A connecting system for connecting an disconnecting a load from a carrying
means, the system comprising:
first connecting means, comprising:
a first housing comprising first connecting point at first end;
a connecting member slidably connected to said first housing at its second end, said connecting member having at least two connecting jags at its end distal from said first connecting point;
spring connected between said first housing and said connecting member adapted to extract when said connecting member slides away from said first end;
second connecting means, comprising:
a second housing comprising second connecting point at its second end, cavity made along its longitudinal axis having an open end at the first end of said second housing;
a second spring enclosed in said cavity;
a first set of levers pivotally connected next to the first end of said second housing symmetrically about its longitudinal axis and extending from the pivot points away from said second end, each of said levers of said first set of levers having a jag proximal to its end that is distal from its pivot point, said jag protruding from its respective lever towards the longitudinal axis of said second housing;
a first spring connected between said levers of said first set of levers adapted to exert force to turn said levers about said pivot points towards the longitudinal axis of said second housing;
a second set of levers having one second lever for each lever of said first set of levers, each of said levers of said second set of levers pivotally connected to its respective lever of said first set of levers proximal to said jag, said lever of said second set of levers extends from said second pivot point and away from said second end of said second housing, and
a second spring connected between the distal ends of said levers of said second set of levers, exerting force to get the distal tips of said levers of said second set of levers closer to each other;
wherein said first connecting means is connected to said second connecting means so that said connecting member is latched onto said jags of said second connecting means via the jags of said connecting members.

2. The system of claim 1 further comprising safety mechanism adapted to ensure that said latched jags may be set apart and cause release of said first connecting means from said second connecting means only after said load has exerted pulling force on said system that is greater than a defined magnitude.

3. A method for disconnecting load from a parachute upon hitting the ground, the system comprising:
providing a first connecting means;
providing a second connecting means, connected to said first connecting means via two or more sets of matching jags;
providing at said second connecting means unlocking mechanism, adapted to disconnect said first connecting means from said connecting means when it is changed to triggered mode;
connecting load at one end of said second connecting means;
connecting parachute at one end of said first connecting means;
exerting pulling force between said first and said second connecting mans to cause the connection of said first and said second connecting means to change to operational stage, thereby causing said unlocking mechanism to change from safe mode to ready mode.

4. The method of claim 3 further comprising providing safety mechanism the ensure that said unlocking mechanism will be enabled to change to triggered mode only after said load has exerted force on said connecting means that is larger than a defined magnitude.
